(19) United States
(12) Patent Application Publication
(10) Pub. No.: US 2012/0104294 A1
(43) Pub. Date: May 3, 2012

(54) Valve Array with CAN Bus Circulation Valve

(75) Inventors: Martin Heusser, Munchen (DE); Peter Scheubert, Aying (DE); Jean Michel Sabatier, Ebersberg (DE)

(73) Assignee: HAWE HYDRAULIK SE, Munchen (DE)

(21) Appl. No.: 13/202,477

(22) PCT Filed: Apr. 16, 2010
(86) PCT No.: PCT/EP2010/002359

§ 371 Date: Dec. 12, 2011

(30) Foreign Application Priority Data
Apr. 17, 2009 (EP) 09 005 477.6

(51) Int. Cl. F16K 31/02

(52) U.S. Cl. 251/129.01

(57) ABSTRACT

The present invention relates to a hydraulic valve array with a CAN bus circulation valve. In particular, a hydraulic valve array is provided, having several modularly joined valve sections (S1-S5, Sx), at least some of which contain at least one electric actuator mechanism (13) and/or sensor mechanism (15) and at least one control and/or evaluation valve electronics (16), and having a communication bus cabling (K) connecting at least some valve sections (S1-S5, Sx) with a central control device (C) for controlling and/or monitoring the valve sections (S1-S5, Sx), wherein a circulation valve section (20) functionally associated to the valve sections (S1-S5, Sx) which is provided with an intelligent circulation valve control (μC1) is structurally integrated in the hydraulic valve array, and wherein the intelligent circulation valve control (μC1) is connected to the communication bus cabling (K) with a communication link (B) at least for communication with at least one valve section (S1-S5, Sx)

The invention relates to a hydraulic valve array according to the preamble of patent claim 1.

It is the known standard of such valve arrays (e.g.: instructions by the Company SAUER DANFOSS, 11/2005, “PVED-CC Series 4 for PVG 32”, No. 157R9960, www.sauer-danfoss.com) to design the cabling to the respective valve electronics contained in the section with individual cables, where the respective actuator and/or sensor mechanism contained in the section is connected with plug-and-socket connectors. In a valve array with four sections, there are e.g. eight plug-and-socket connections and correspondingly many cable loops. According to a daisy chain method, the sections lying next to each other are each connected via the power supply loops and signal cable loops of a bus cable (CAN bus). Accordingly, at least two plug-and-socket connectors must be attached at each section. The costs for the preparation and attachment of the many cable loops and plug-and-socket connectors are high. However, the disadvantage that the plug-and-socket connectors require relatively much space that is hardly available especially in smaller designs is severe and complicates the attachment and removal of the plug-and-socket connectors. Moreover, there is a risk in that, for example in the field of mobile hydraulics, plug-and-socket connectors and/or cable loops between the pin-and-socket connectors are damaged or pulled off under severe operating conditions.

For industrial applications, it is common in interiors with stationary devices to lay bus lines for example as twin-wire coded cables. If above all a high degree of freedom to expand or restrict or remodel linked devices at any time in such factories is essential, a design of the cabling e.g. in the form of the so-called ASI bus system is established (information document NEXAN, SN 24017 of Jun. 14, 2007, “Energiebusleitung ASI mit Polyurethan-Mantel HI11Y-FL”). A comparable standard is at present not employed for hydraulic valve arrays due to completely different requirements and due to the not necessarily required degree of freedom to remodel, presumably also because standards established for hydraulic valve arrays proved of value and fears and prejudices in view of safety relevance existed.

Due to such prejudices in view of safety relevance, circulation valves are not integrated into the bus system of valve arrays but controlled separately from the bus system to create redundancy that serves safety. Circulation valves are used to quickly remove the high pressure of up to several hundred bars from the system in case of conditions of hydraulic systems that threaten safety.

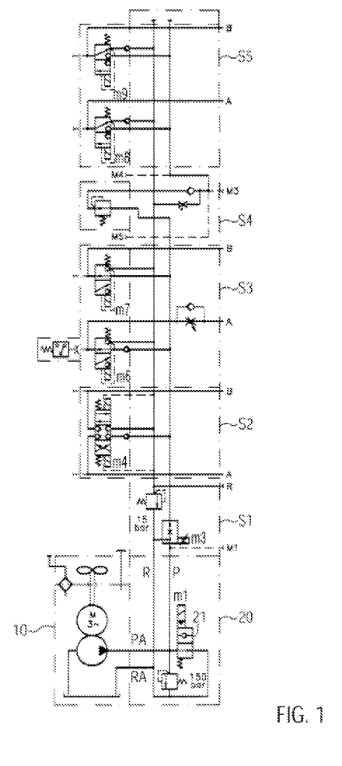

One example of a hydraulic system that uses a valve array and a circulation valve is shown in FIG. 1. FIG. 1 shows a hydraulic system with a pump unit 10 which is connected to a valve array with five valve sections S1, S2, S3, S4, and S5 via a connection block 20. In the example shown in FIG. 1, the valve sections S2, S3, and S5 serve the control of pressure supply to consumers by multidirectional spool valves or seated valves via working lines A and B. The valve section S4 contains a discharge valve, and the valve section S1 acts as volume flow control by means of a proportional flow controller. The connection block 20 connects the pump block 10 with the valve array, consisting of S1 to S5. The connection block 20 contains a circulation valve 21 by means of which the pressure from the connection PA to the pump block 10 can be bypassed into the reservoir via the return connection RA. In normal operation, when the return valve 21 is fed with current so that the return valve 21 shuts off, the pressure is forwarded to the pressure line P which feeds the valve sections S1 to S5.

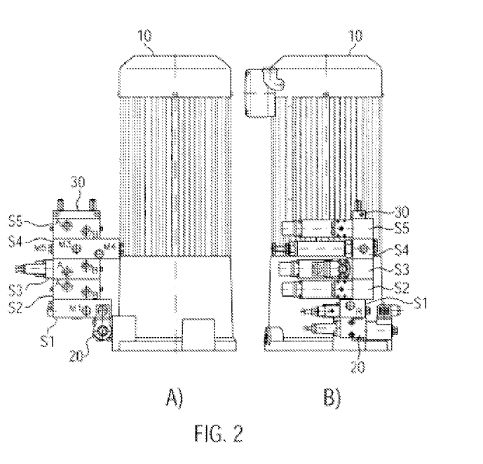

FIGS. 2A and B show two different views of a hydraulic system which realizes the hydraulic circuit diagram of FIG. 1. In FIG. 2, the valve sections S1 to S5 are stacked and connected with each other via a mounting plate 30. The connection block 20 with integrated circulation valve 21 and pressure limiting valve acts as connection between the valve array and the pump block 10.

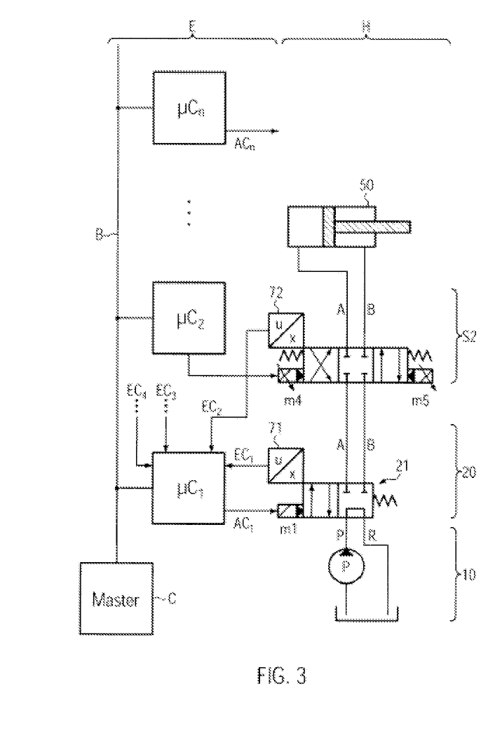

As can be seen in FIG. 1, the valves in the connection block 20 and the valve sections S1 to S5 can be electrically actuated by solenoids m1, m4, m5, m6, m7, m8, and m9. FIG. 3 schematically shows how the hydraulic system of FIG. 1 can be electrically controlled. To show the difficulty, however, the complex hydraulic circuit diagram of FIG. 1 was simplified. FIG. 3 now shows the pump section 10, the connection block 20 with the circulation valve 21, however without the pressure limiting valve of FIG. 1, and the valve section S2 with a 4/3-port slide valve for controlling a double-action piston 50 as consumer. This simplified representation of the hydraulic circuit example of FIG. 1 is represented on the right of FIG. 3 with the designation H.

A recommendation for the electric control of such a hydraulic circuit which meets safety-relevant requirements is given in the BGIA report 2/2008 for the functional safety of machine controls by the “Berufsgenossenschaftliches Institut für Arbeitssicherheit BGIA” on page 130. The BGIA report shows as an example of a safety-related part of the control (safety related parts of control systems, SRP/CS), an earth-moving machinery control with bus system by means of which an unexpected start is to be prevented, i.e. unexpected movements of the equipment of earth-moving machinery are to be avoided. Signals for controlling the proportional multiway valve of valve section S2 run via the communication link B (bus line). For this, the signals are received by a controller μC2 with bus capability, interpreted and forwarded to the proportional solenoids m4 and m5 via a control line AC2 for controlling the multiway valve. In FIG. 3, the electric connections are shown on the left in the figure with the designation E. Another controller μC1 receives a redundant signal from the bus line B. The further controller μC1 is furthermore directly connected with a position-measuring system 72 of the multidirectional spool valve of valve section S2. The further controller μC1 evaluates the signals of the position-measuring system 72 and the signal on the bus line B and decides whether the consumer 50 carries out an unexpected movement. In case of an unexpected movement, the further microcontroller μC1 switches off the current feed of the solenoid m1 of the circulation valve 21 via the control line AC1, so that the circulation valve 21 is adjusted to the non-operative state by the internal spring, while the pump pumps back hydraulic liquid directly via the return line R into the reservoir. Further sensors, such as position sensors 71 or pressure sensors (not shown), are connected with the further microcontroller μC1 via direct connection leads EC1, EC3, EC4 to identify unexpected movements and correspondingly control the circulation valve 21. Further control units μCn for additional valve sections can be added, as indicated in FIG. 3.

For the overall control of the various components, a central control device C is used which communicates via the bus line B with all control electronics μC1, μC2, . . . , μCn to control valve sections. To ensure system safety, the monitoring sensors 71 and 72 are directly connected to the controller μC1 which controls the circulation valve 21, while the valve section controls μC2, . . . , μCn are bypassed. By this type of redundancy, the cabling efforts, however, become considerable as for the bus cabling, signal cable loops between all valve sections are required, and moreover extra cable loops between the control section of the circulation valve and the various measuring systems in the hydraulic system are required. In addition, power supply loops to the individual components are necessary.

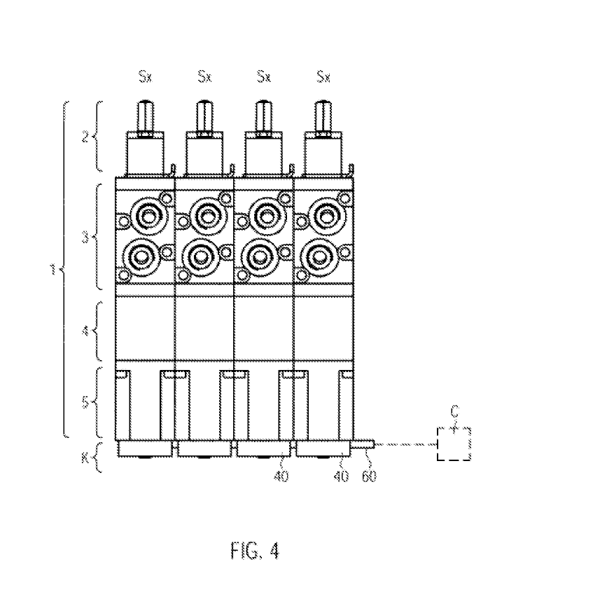

A first facilitation of the cabling is suggested in the European patent application 07 022 710.3 (not yet published) of the Company HAWE Hydraulik SE. This is schematically shown in FIG. 4. FIG. 4 shows a valve array with four valve sections which, for the sake of simplicity, are represented identically in FIG. 4 and designated with Sx. The number of sections is only given by way of example and could be higher or lower than shown. In the shown embodiment, each section Sx has a cuboid-shaped block 1, e.g. of steel. The blocks 1 are joined in the valve array such that there are non-depicted flow passages between the blocks. As an alternative, several sections could be contained in one group block, or one common block could be provided for all sections. Sections of approximately the same height are shown, although the heights and/or widths of the sections can also vary within the valve array. Each valve section has an actuation side 2, for example with hand levers at the upper side which are not indicated more in detail. Furthermore, each valve section contains a fluidic section 3 with e.g. fluid supplies A and B. In a further region 4, an actuator mechanism for actively actuating e.g. the directional control slide valves is contained. In a further section 5 of the valve sections, the valve electronics are accommodated. At the bottom side of the valve sections shown in FIG. 4, the cabling K is attached. The cabling K is provided in the form of parallel cables 60 which connect valve sections with each other and with a higher-order control C with contact links without plugs which are mounted via frictionally fixed covers 40.

The hydraulic valve array suggested in the patent application 07 022 710.3, however, does not provide any correspondingly contactable circulation valve section that can be structurally integrated into the array, due to the safety-related fears and prejudices as they have been described above.

The object underlying the invention is to provide a hydraulic valve array of the type mentioned in the beginning which is characterized by an inexpensive, space-saving, reliable and damage-resistant cabling, and into which a circulation valve can be integrated as independent modular valve section which comprises a connection compatible for inexpensive, space-saving, reliable and damage-resistant cabling.

The object is achieved with the features of claim 1.

Accordingly, a circulation valve section provided with an intelligent circulation valve control and functionally associated to the valve sections is structurally integrated into the hydraulic valve array, and the intelligent circulation valve control is connected to a communication bus cabling at least for communication with at least one valve section with a communication link.

Thereby, a flexible modular valve array system is provided which facilitates cabling to a circulation valve section without compromising its safety functions. Moreover, the structural integration of the circulation valve with other valve sections as well as the communication cabling permits a more closed system concept which is more flexible and easier to assemble, configure and maintain.

In one embodiment according to claim 2, the circulation valve section can be actuated directly or via the intelligent circulation valve control additionally independent of the communication link with the communication bus cabling. By the additional option to actuate the circulation valve independently of the communication link, the safety function of the circulation valve section is improved.

In a further embodiment according to claim 3, the intelligent circulation valve control comprises at least one processor. By the processor, the circulation valve section can be more flexibly adapted to system designs, it becomes more independent of the complete system and safer as additional electronic safety and control functions can also be subsequently installed in terms of software.

In another embodiment according to claim 4, the communication bus cabling and the communication link correspond to a CAN bus specification. The CAN bus is a wide-spread industrial standard and ensures compatibility and the keeping of safety functions in combinations of components of different manufacturers. System maintenance and configuration is also facilitated in standardized components.

In a further embodiment according to claim 5, the intelligent circulation valve control is designed such that it processes the signals on the communication bus cabling and uses them for controlling the circulation valve section. In this embodiment, the intelligent circulation valve control monitors the communication on the communication bus cabling and on the basis of the communication decides whether the system is getting into a safety-relevant critical state to optionally remove the pressure from the system.

In another embodiment according to claim 6, at least one of the valve sections is equipped with a processor which controls a valve section or a group of valve sections. By the processor, the corresponding valve section can be more flexibly adapted to system designs, it becomes more independent of the complete system and safer as additional electronic control functions can also be subsequently installed in terms of software.

In an embodiment according to claim 7, the central control device is connected to the communication bus cabling, and the circulation valve section can also be actuated independent of signals from the central control device on the communication bus link, preferably by a system or load pressure controller or an emergency stop switch, preferably via a hard wiring to an actuator of the circulation valve section bypassing the processor. In this embodiment, the intelligent circulation valve control is separate from the central control device and controllable independently of it, whereby redundancy and thus also safety are increased.

In a further embodiment according to claim 8, the intelligent circulation valve control is designed such that it is used at the communication bus cabling as the central control device for a hydraulic system with the hydraulic valve array. As the intelligence of the intelligent circulation valve control can also be used for higher-order control functions, a resource-efficient realization of a complete hydraulic system can be achieved with this embodiment.

In another embodiment according to claim 9, a circulation valve of the circulation valve section comprises a proportional solenoid as actuator. By this, the circulation valve section can more flexibly react to failures, e.g. by not lowering the pressure in the system to zero but only to a suited lowered value which is sufficient, for example, to prevent an undesired dangerous movement of a hydraulic consumer, for example a swivel arm.

In a further embodiment according to claim 10, the actuator of the circulation valve of the circulation valve section is supplied with current in normal operation, so that the circulation valve supply pressure for consumers connected to the valve sections is forwarded, and in a state where the actuator is not supplied with current, a spring adjusts the circulation valve such that the circulation valve supply pressure is lead into a reservoir. This circuitry of the circulation valve has the advantage that, in case of a mains failure, the spring automatically adjusts the circulation valve to the position in which the pump pressure is lead into the reservoir and the system is thus relieved from pressure.

In a further embodiment according to claim 11, the hydraulic valve array furthermore comprises position or pressure sensors connected to the communication bus cabling. The position or pressure sensors act as further safety means by which the state of the hydraulic system is monitored to optionally switch it off.

In an embodiment according to claim 12, the position or/and pressure sensors comprise control and/or evaluation sensor electronics which are connected to the communication bus cabling. Thereby, cumbersome cross cabling is omitted and the assembly and maintenance of the system is facilitated.

In an embodiment according to claim 13, the position or/and pressure sensors are directly connected to the intelligent circulation valve control, functionally associated to the circulation valve section or even incorporated in the same. To increase redundancy and thus improve the system safety, the position or/and pressure sensors can be directly connected to the intelligent circulation valve control, so that the intelligent circulation valve control receives information on the system state despite a failure of the bus system.

In a further embodiment according to claim 14, as at least one further section structurally integrated in the valve array, a wireless function control and/or monitoring section is provided and connected to the communication bus cabling with the communication link. Thereby, the flexibility of the valve array is considerably increased as not only external computers can be cordlessly incorporated as control device, but also sensors and valves can be wirelessly incorporated at regions which are difficult to access.

In still another embodiment according to claim 15, the communication bus cabling comprises at least one cable continuously extending via a housing of the sensor/valve electronics and the intelligent circulation valve control, a contact link without plug with at least one contact mandrel per wire of the cable which is force-fit pressed into the cable is provided between the cable and the sensor/valve electronics or the intelligent circulation valve control, respectively, the contact link comprises a cover with a positioning seat for the cable which covers the cable and which can be attached onto the housing of the sensor/valve electronics or the intelligent circulation valve control by force-fit and pressing, and the at least one contact mandrel is arranged in at least one socket installed in a passage of the housing of the sensor/valve electronics or the intelligent circulation valve control and projects outwards from the housing transversely to the direction of extension of the cable into the positioning seat and is connected in the housing to at least one printed circuit board of the sensor/valve electronics or the intelligent circulation valve control attached to the socket.

With this embodiment, simple contacting between the valve sections and the bus cabling is achieved, whereby in particular assembly is facilitated and expensive plug-and-socket connections can be omitted.

With reference to the drawings, embodiments of the invention will be illustrated. It is shown by:

FIG. 1, by way of example, a hydraulic system by a fluid circuit diagram according to prior art;

FIG. 2, a diagram of a realization of the system of FIG. 1;

FIG. 3, a detail of the hydraulic diagram of FIG. 1 additionally with its electric control;

FIG. 4, essential elements of a valve array with integrated bus system according to prior art;

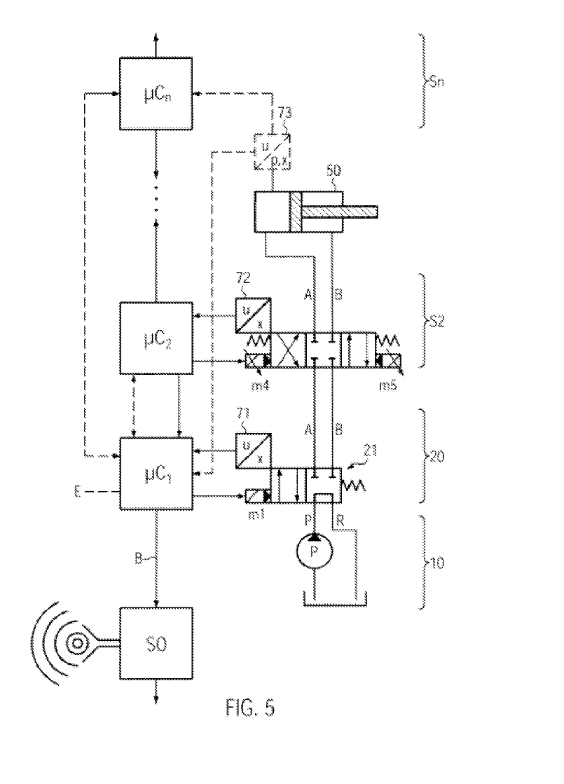

FIG. 5, a hydraulic diagram with an electric control for a hydraulic valve array according to the present invention;

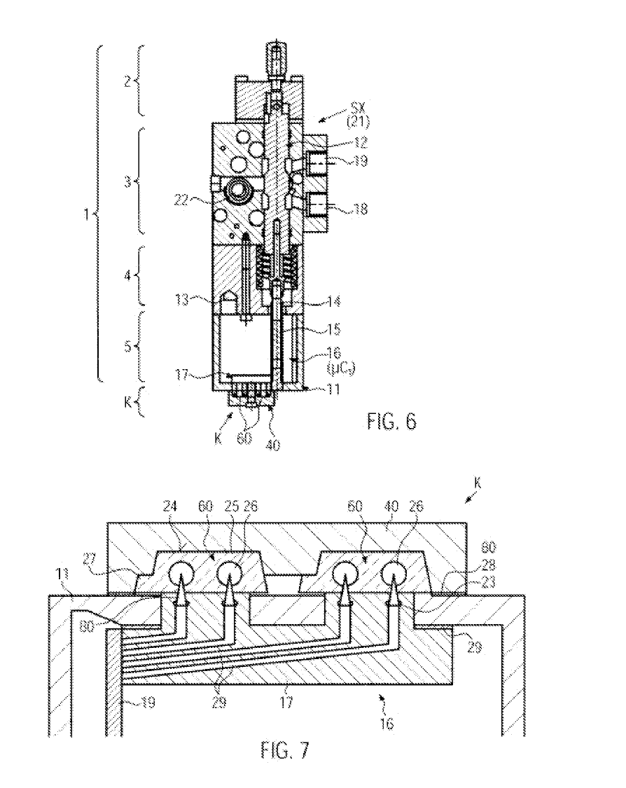

FIG. 6, a cross-section of a valve of a hydraulic valve array with an integrated actuator and/or sensor mechanism as well as control and/or evaluation electronics, including a communication bus cabling of the present invention; and

FIG. 7, an enlarged section of FIG. 6 for clarifying the cabling of the sections.

It should be noted that in the figures and in the description, reference numeral K designates a communication bus cabling, and reference numeral B designates a communication link. The two designations have been introduced to distinguish between various abstraction levels. Communication bus cabling K means the hardware design of the cabling, i.e. position, thickness, material, mounting, etc. of the cabling, Communication link B means the higher-order abstraction level, i.e. the signal level, bus protocols, timing, etc. on the communication cabling K. In the figures, this is clarified by the communication bus being designated with reference numeral B in the electro-fluidic circuit diagrams to allow for the higher abstraction level, and in the technical cross-sectional drawings 6 and 7, the bus cabling is designated with reference numeral K.

Some important aspects of the present invention will now be illustrated with reference to FIG. 5. FIG. 5 shows a modification of the electro-fluidic circuit diagram of FIG. 3. In contrast to FIG. 3, the valve segments 20 and S2 are modular units in FIG. 5 which can be independently combined in one valve array. That means, the modules S2 and 20 can be used as independent valve segments. In contrast to this, the valve segment S2 of FIG. 3 needs the segment 20 (connection block) of FIG. 3 for evaluating the valve sensor mechanism 72. To be able to act as independent, modularly usable segment, each valve section of FIG. 5 therefore contains the same basic elements which have already been discussed in connection with FIG. 4, that means a fluidic part (e.g. a valve 21), an electrically actuated actuator mechanism (solenoids m1, m4, m5), a sensor mechanism (e.g. position sensors of the valves 71, 72), and a control and/or evaluation electronics which is represented in FIG. 5 as processor-supported control and evaluation circuit μC1 and μC2. The sensor and actuator mechanisms of one single valve section first cooperate with the own control and/or evaluation valve electronics independent of other valve sections. The control and/or evaluation valve electronics of each valve section moreover comprises a standardized communication bus interface for connection to a standardized bus system. The system can also contain position and pressure sensors 73, e.g. to detect the pressure on a load sensing line or the position of a hydraulic consumer, for example a swivel arm driven by a hydraulic cylinder 50. Such sensor systems can be designed e.g. as independent modules with separate intelligent evaluation electronics and bus interface μCn. As an alternative, the sensor mechanism can also be integrated e.g. in the circulation valve section 20 or connected to the same (indicated by a dashed line). To increase redundancy, additional bus lines can also be provided which provide an additional connection between the individual valve/sensor electronics μC2, . . . , μCn, and the intelligent circulation valve control μC1 (indicated by dashed lines). An external input E into the intelligent circulation valve control μC1 can be used e.g. for a manually actuated emergency stop switch. To permit an emergency stop function even in case of electric failures, the circulation valve 21 can comprise a mechanical manual valve actuation and/or a manually actuated interruption of circuit of the actuator m1.

In FIG. 5, a section S0 is shown which permits wireless communication with the bus system, by which not only external computers can be cordlessly incorporated as control device, but also, for example, sensors and valves can be wirelessly incorporated at regions which are difficult to access.

As each module, valve section 20, S2, sensor section Sn, or wireless communication section S0, can have its own processor μC1, μC2, μCn, it is possible to program each section as master of the complete bus system or as control of a part of the bus system with corresponding sections. However, an independent computer module which functions as higher-order and central control device can also be connected to the bus system. Ideally, the intelligent circulation valve control μC1 can be used as central control device as the intelligent circulation valve control μC1 must detect and evaluate all safety-relevant sensory data of the hydraulic system to possibly induce a pressure relieve of the system.

To clarify the modular character of the present invention, a cross-section through a valve section Sx, as it is already indicated in FIG. 4, is shown in FIG. 6. FIG. 6 shows a piston valve 12 movable in a block 1 which can be optionally adjusted manually at the operational side 2, and by an actuator mechanism 13, e.g. twin solenoids, which is contained in the actuator section 4. In the housing 11 of the electronic section 5 mounted at the actuator section 4, the valve electronics 16 is contained and can also comprise a processor which imparts intelligence to the electronics. Equally, the bus interface is contained in the valve electronics 16. An extension part 14 is connected to the piston valve 12 which extension part 14 is part of a sensor mechanism 15, for example a distance sensor with a permanent bar magnet. The sensor mechanism 15 could, as an alternative, consist of an incremental distance sensor. Optionally, the sensor mechanism 15 comprises a control unit and/or a measuring device and/or a counter or the like. With the sensor mechanism 15, for example a distance sensor, the correct position of the directional control slide valve is monitored and/or controlled. In the housing 11 of the electronic section 5, a socket 17 is mounted which is required for creating a contact link without plug with cables 60 of the communication bus cabling K. In FIG. 6, a cable 60 is shown which consists of two twin-wire cable strands extending in parallel. Instead of two cables 60 as shown, one single cable or a multi-wire flat ribbon cable can also be installed.

The design of the valve section shown in FIG. 6 also permits the use as circulation valve section 20. The fluidic part of the circulation valve section 20, however, can also have a design different to that known in prior art. In the representation shown in FIG. 6, a spring pushes the slide piston 12 upwards, so that a connection between the channel 22 and the channel 19 is created. If the channel 22 is connected with the pump connection (see FIG. 1, reference numeral PA), and if the channel 19 is connected with the return connection (see FIG. 1, reference numeral RA), the pump pumps hydraulic liquid into the reservoir and the system is pressure-relieved. If the internal actuators (solenoid m1 of FIG. 1, 3 or 5) are actuated, the piston 12 moves downwards, and a connection between the channel 22 and the channel 18 is created. If the channel 18 is connected with the pressure line (see FIG. 1, reference numeral P), the valve shown in FIG. 6 can fulfill a circulation valve function.

FIG. 7 shows an enlarged detail of FIG. 6 to illustrate the design of the contact link without plug between the valve electronics 16 and the cables 60. At its bottom side, a cover 40 has at least one positioning seat 24 (in the present case two similar positioning seats 24) whose cross-section is adapted to the cross-section of the insulating envelope of the cable 60. The cable 60 is, for example, a so-called ASI bus cable with two parallel wires 26 and the elastic insulating envelope 25 of piercable material. The insulating envelope 25 in this embodiment has a trapezoidal cross-section with a profile projection 27 associated to a wire 26 at a sloping side of the trapezoid. The positioning seat 24 is exactly adapted to the cross-sectional shape of the insulating envelope 25. If another cable is used, the positioning seat 24 needs a different cross-section to be able to exactly position the cable and press it against the contact mandrels 80 in the positioned state. In the socket 17, several contact mandrels 80 are embedded, which are connected to the printed circuit board 19 mounted in the socket 17 via lines 29. The contact mandrels 80 project to such an extent beyond the socket 17 into the positioning seat 25 that, when the cover 40 is force-fit pressed on with positioned cables 60, the contact mandrels 80 pierce the insulating envelopes 25 and penetrate into the wires 26 to create the contact. A seal 28 can be provided between the housing 11 and the cover 40. Between the socket 17 and the housing 11, too, a seal 29 can be provided. Moreover, for each cable 60, a separate cover 40 could be provided. Appropriately, for example without using at least the seal 28, the elasticity of the insulating envelope 25 of the cable 60 is used to create the required tightness via the contact pressure of the cover 4.

In FIG. 7, the two cables 60 are installed in the positioning seats 24 in the same direction, i.e. each profile projection 27 points to the left. Mechanics or customers who mount or exchange the cables 6 or exchange a section could thus unintentionally confuse the cables 60, so that, for example, the supply current could destroy the valve electronics. To prevent this, in a non-depicted alternative, the two positioning seats 24 of the cover 40 of FIG. 7 could be arranged to be laterally reversed, and the two cables 60 could also be installed such that with both cables 60, the profile projections 27 face each other. In case of one single cable (not shown) which contains wires 26 for the power supply and wires for the communication, this is advantageously embodied with an asymmetrical cross-section, just as the single positioning seat 24, to enforce one single and correct installation position of the cable.

Optionally, a multi-wire cable, for example a flat ribbon cable, which can also have an asymmetrical design to prevent incorrect assembly, can be used to provide additional lines for connections of individual sensors or individual sensor or valve electronics to the intelligent circulation valve control μC1 as integral component of the communication bus cabling.

1. Hydraulic valve array,
having several, modularly joined valve sections at least some of which contain at least one of an electric actuator mechanism and a sensor mechanism and at least one of a valve control electronics and a valve evaluation valve electronics, and
having a communication bus cabling connecting at least some valve sections with a central control device for at least one of controlling and monitoring the valve sections,
wherein a circulation valve section functionally associated to the valve sections is structurally integrated in the hydraulic valve array, the circulation valve section being provided with an intelligent circulation valve control, and the intelligent circulation valve control is connected to the communication bus cabling (K) at least for communication with at least one valve section with a communication link.

2. Hydraulic valve array according to claim 1, wherein the circulation valve section can be actuated one of directly and via the intelligent circulation valve control, additionally independent of the communication link with the communication bus cabling.

3. Hydraulic valve array according to claim 1, wherein the intelligent circulation valve control comprises at least one processor.

4. Hydraulic valve array according to claim 1, wherein the communication bus cabling and the communication link correspond to a CAN bus specification.

5. Hydraulic valve array according to claim 1, wherein the intelligent circulation valve control is designed such that it processes the signals on the communication bus cabling and uses them for controlling the circulation valve section.

6. Hydraulic valve array according to claim 1, wherein at least one of the valve sections is equipped with a processor which controls at least one of a valve section and a group of valve sections.

7. Hydraulic valve array according to claim 1, wherein the central control device is connected to the communication bus cabling, and wherein the circulation valve section can also be actuated independent of signals from the central control device on the communication bus link.

8. Hydraulic valve array according to claim 1, wherein the intelligent circulation valve control is designed such that it is used at the communication bus cabling as the central control device for a hydraulic system with the hydraulic valve array.

9. Hydraulic valve array according to claim 1, wherein a circulation valve of the circulation valve section (20) comprises a proportional solenoid as actuator.

10. Hydraulic valve array according to claim 9, wherein the actuator of the circulation valve of the circulation valve section is supplied with current in normal operation, so that the circulation valve supply pressure for consumers connected to the valve sections is forwarded, and wherein in a state where the actuator is not supplied with current, a spring adjusts the circulation valve such that the circulation valve supply pressure is lead into a reservoir.

11. Hydraulic valve array according to claim 1, wherein the hydraulic valve array furthermore comprises at least one of a position and a pressure sensor connected to the communication bus cabling.

12. Hydraulic valve array according to claim 11, wherein the at least one of position and pressure sensors comprise at least one of control and evaluation sensor electronics which are connected to the communication bus cabling.

13. Hydraulic valve array according to claim 12, wherein the at least one of position and pressure sensors are one of directly connected to the intelligent circulation valve control, functionally associated to the circulation valve section and incorporated in the same.

14. Hydraulic valve array according to claim 1, wherein as at least one further section structurally integrated in the valve array, a wireless function control and/or monitoring section is provided and connected with the communication link to the communication bus cabling.

15. Hydraulic valve array according to claim 1, wherein the communication bus cabling comprises at least one cable continuously extending via a housing of the sensor/valve electronics and the intelligent circulation valve control, that between the cable and the sensor/valve electronics or the intelligent circulation valve control, a contact link without plug with at least one contact mandrel per wire of the cable force-fit pressed into the cable is provided, that the contact link comprises a cover with a positioning seat for the cable which covers the cable and can be attached onto the housing of the sensor/valve electronics or the intelligent circulation valve control by force-fit and pressing, and that the at least one contact mandrel is arranged in at least one socket installed in a passage of the housing of the sensor/valve electronics or the intelligent circulation valve control and projects from the housing transversely to the direction of extension of the cable outwards into the positioning seat, and is connected in the housing to at least one printed circuit board of the sensor/valve electronics or the intelligent circulation valve control attached to the socket.

16. Hydraulic valve array,
having several, modularly joined valve sections at least some of which contain at least one of an electric actuator mechanism, a sensor mechanism, a valve control electronics and a valve evaluation electronics, and
having a CAN bus cabling connecting at least some valve sections with a central control device for at least one of controlling and/or monitoring the valve sections,
wherein a circulation valve section functionally associated to the valve sections is structurally integrated in the hydraulic valve array, the circulation valve section being provided with an intelligent circulation valve control,
wherein the intelligent circulation valve control is connected to the CAN bus cabling at least for communication with at least one valve section with a communication link,
wherein the circulation valve section can be actuated directly or via the intelligent circulation valve control, additionally independent of the communication link with the communication bus cabling,
wherein the intelligent circulation valve control is designed such that it processes the signals on the CAN bus cabling and uses them for controlling the circulation valve section.

17. Hydraulic valve array according to claims 16, wherein the central control device is connected to the communication bus cabling, and wherein the circulation valve section can also be actuated independent of signals from the central control device on the communication bus link, preferably by one of a system controller, a load pressure controller and an emergency stop switch, preferably via a hard wiring to an actuator of the circulation valve section bypassing the processor.

18. Hydraulic valve array,
having several, modularly joined valve sections at least some of which contain at least one of an electric actuator mechanism, a sensor mechanism, a valve control electronics and a valve evaluation electronics, and
having a CAN bus cabling connecting at least some valve sections with a central control device for at least one of controlling and/or monitoring the valve sections,
wherein a circulation valve section functionally associated to the valve sections is structurally integrated in the hydraulic valve array, the circulation valve section being provided with an intelligent circulation valve control,
wherein the intelligent circulation valve control is connected to the CAN bus cabling at least for communication with at least one valve section with a communication link,
wherein the circulation valve section can be actuated directly or via the intelligent circulation valve control, additionally independent of the communication link with the communication bus cabling,
wherein the intelligent circulation valve control is designed such that it processes the signals on the CAN bus cabling and uses them for controlling the circulation valve section,
wherein the communication bus cabling comprises at least one cable continuously extending via a housing of the sensor/valve electronics and the intelligent circulation valve control, that between the cable and the sensor/valve electronics or the intelligent circulation valve control, a contact link without plug with at least one contact mandrel per wire of the cable force-fit pressed into the cable is provided, that the contact link comprises a cover with a positioning seat for the cable which covers the cable and can be attached onto the housing of the sensor/valve electronics or the intelligent circulation valve control by force-fit and pressing, and that the at least one contact mandrel is arranged in at least one socket installed in a passage of the housing of the sensor/valve electronics or the intelligent circulation valve control and projects from the housing transversely to the direction of extension of the cable outwards into the positioning seat, and is connected in the housing to at least one printed circuit board of the sensor/valve electronics or the intelligent circulation valve control attached to the socket.

19. Hydraulic valve array according to claim 7, wherein the circulation valve section is actuated independent of signals from the central control device on the communication bus link by a system controller, a load pressure controller and an emergency stop switch.

20. Hydraulic valve array according to claim 19, wherein the circulation valve section is actuated independent of signals from the central control device on the communication bus link by a system controller, a load pressure controller and an emergency stop switch via a hard wiring to an actuator of the circulation valve section bypassing the processor.
